(19) United States
(12) Patent Application Publication
(10) Pub. No.: US 2016/0245653 A1
(43) Pub. Date: Aug. 25, 2016

(54) CYLINDRICAL RESONATOR GYROSCOPE

(71) Applicants: Sangtae Park, San Ramon, CA (US); Satinderpall S. Pannu, Pleasanton, CA (US)

(72) Inventors: Sangtae Park, San Ramon, CA (US); Satinderpall S. Pannu, Pleasanton, CA (US)

(21) Appl. No.: 14/267,891

(22) Filed: May 1, 2014

Related U.S. Application Data
(60) Provisional application No. 61/817,796, filed on Apr. 30, 2013.

(51) Int. Cl. G01C 19/5684

(52) U.S. Cl. CPC G01C 19/5684

(57) ABSTRACT

A quartz vibratory gyroscope comprises a substrate, a quartz cylindrical ring having one end connected to the substrate and an opposite open end, and a radial surface lined with an electrically conductive material, and a pair (or more) of electrodes arranged adjacent opposite sections of the electrically conductive material to electrically induce resonance at the open end of the quartz cylindrical ring, such as by electrostatic actuation or piezoelectric actuation. The same or additional electrode pairs may be used for rotational sensing, such as by capacitive sensing or by piezoelectric sensing.

### CROSS-REFERENCE TO RELATED APPLICATIONS

This application claims the benefit of U.S. provisional application No. 61/817,976 filed May 1, 2014, which is incorporated by reference herein.

### FEDERALLY SPONSORED RESEARCH OR DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory.

### BACKGROUND

Quartz vibratory gyroscopes are known which utilize quartz as the resonating material due its high quality factor (Q) even at atmospheric pressure and its stability with respect to temperature variations and other environmental changes. This is important for the motion sensing capability of the device, especially in high-end gyroscope applications.

One particular design of quartz vibratory gyroscope is the hemispherical resonator gyroscope (HRG) described in the article, “The Hemispherical Resonator Gyro: From Wineglass to the Planets” by David M. Rozelle (Spacefl. Mech. 2009), incorporated by reference herein. The HRG is known for its low noise, high performance, and long-term reliability needed for space mission and defense applications. However, the HRG and other types of quartz gyroscopes are typically bulky and assembled using complex and expensive assembly processes.

### SUMMARY

The cylindrical resonator gyroscope of the present invention is designed to perform rotational sensing based on the same physical principles of the HRG, and includes a resonating component made of quartz and shaped as a low-profile cylinder, i.e. cylindrical ring, and a substrate (e.g. glass) for physical staging and metal routing. The two layers may be bonded, for example, by thermal compression bond or any other wafer bonding method. And a set of at least one pair of electrodes (e.g. two pair, or four total electrodes) is also connected to (e.g. formed on) the substrate and circumferentially arranged outside of and around the quartz cylindrical ring. The quartz cylindrical ring has a radial surface (i.e. either the radially inner surface or the radially outer surface of the cylinder) that is lined with an electrically conductive material. And routing metal (metal trace) is also formed on the substrate for connecting to the electrode material.

The cylindrical ring mass in the center is driven electrostatically by the at least one pair of electrodes (e.g. four total), which may be formed on stationary structures arranged around the cylindrical ring. This will excite the first mode of vibration—vibrating from circular to ellipsoidal, back to circular, and then to ellipsoidal (in orthogonal direction) shapes changing every quarter of the cycle. The gyroscope may be operated in the tens to hundreds of kHz range, or up to MHz range, depending on the dimensions and stiffness of the cylindrical resonator. It is appreciated that electrostatic or piezoelectric actuation may be used.

Rotational sensing is based on the principle that Corilolis forces on the vibrating mass due to rotation about the z-axis will cause the standing wave pattern (mode shape) to rotate by an angle that is a product of the angular gain factor (close to 0.3 in the case of HRG) and an inertial rotation angle. Rotation of the standing wave pattern can be sensed electrostatically by the a pair of opposing electrodes or additional pairs of electrodes may be used for higher angular resolution. Sensing and driving can be done using two different set of electrodes (higher number of electrodes in the segmented case).

In the alternative, both sensing and driving can be done using the same electrodes but will need to time-multiplex between the two modes. These electrostatic electrodes can be further segmented for higher angular resolution and to enhance design flexibility for sharing total “electrode signal” between drive and sense modes of operation.

In still another alternative, rotation of the standing wave pattern can be sensed piezoelectrically. In particular, the sidewall metal on the vibrating cylinder can be used to sense the rotation of the standing wave pattern by quartz piezoelectric effect. In one example the sidewall metal is divided into four quadrants. These piezoelectric electrodes can be further divided for higher angular resolution and to enhance design flexibility for sharing total “electrode signal” between drive and sense modes of operation. The movement of the antinode of the standing wave pattern across the single quadrant sidewall electrode should provide sufficient signal gradient with respect to rotation angle (by the changing of total shear stress value). If not, the sidewall metal can be further divided for higher angular resolution. One benefit of using piezoelectric effect for sensing is that different set of electrodes can be used without having to share the total “electrostatic electrode signal” between driving and sensing. It may also provide higher sensing capability by measuring the actual stress of the structure. Optionally additional electrodes may be provided on the inner surface of the cylindrical mass, to be used for piezoelectric sensing only.

It is appreciated that as used herein and in the claims, a “cylindrical” shape can have a conventional circular cross-section, as well as any other cross-sectional shape. Generally, any 3D shape may be used that is symmetrical and that also has certain amount of flexibility to vibrate in a certain mode shape, and that is also easy to detect around the boundaries. It is appreciated that the ring width is sufficiently thin to vibrate with finite energy afforded by the actuation mechanism. On the other hand, the width-to-diameter ratio as well as width-to-axial length ratio is important for the same reason.

Various state of the art microfabrication technologies may be utilized to batch fabricate the MEMS cylindrical resonator gyroscope of the present invention. One method would be to etch a quartz layer on a temporary carrier substrate, pattern the metal layers on both top and sidewall, and then bond it to the glass substrate thereafter. On the opposite side, the metal planar electrodes on the glass substrate will need to be patterned before bonding; note that these are also used as a thermal compression material.

In one example implementation, a quartz vibratory gyroscope is provided comprising: a substrate; an electrode material-lined quartz cylindrical ring formed on the substrate; and at least four electrodes formed on the substrate and circumferentially arranged around the electrode material-lined quartz cylindrical ring to electrostatically induce vibration thereof. Optionally, the at least four electrodes may be adapted to both drive and sense the vibration of the electrode material-lined quartz cylindrical ring, or the at least four electrodes may have a first subset adapted to drive the vibration, and a second subset adapted to sense the vibration. It is appreciated that capacitive sensors may be used for sensing the vibration. Furthermore, the second subset of electrodes may be adapted to sense the vibration by the piezoelectric effect. Still further, the electrode material-lined quartz cylindrical ring may be bonded to the substrate, such as by Au thermal compression. These and other implementations and various features and operations are described in greater detail in the drawings, the description and the claims.

In one example implementation, a quartz vibratory gyroscope is provided comprising: a substrate; a quartz cylindrical ring having one end connected to the substrate and an opposite open end, and a radial surface lined with an electrically conductive material; and a pair of electrodes arranged adjacent opposite sections of the electrically conductive material to electrically induce resonance at the open end of the quartz cylindrical ring. The example implementation may also be subject to various optional features, as follows:

Optionally, the electrically conductive materials may lines an outer radial surface of the quartz cylindrical ring, and the pair of electrodes is arranged outside the electrically conductive material-lined quartz cylindrical ring. Furthermore, the pair of electrodes may be adapted to be time-multiplexed to alternate between electrostatic actuation and capacitive sensing operational modes. The quartz vibratory gyroscope may further comprise at least one additional pair of electrodes arranged adjacent opposite sections of the electrically conductive material, and said pairs of electrodes may each be adapted to operate as an electrostatic actuator or as a capacitive sensor. Furthermore, the gyroscope may further comprise a pair of electrodes lining an inner radial surface of the quartz cylindrical ring at different radial sections from the pair of electrodes arranged outside the electrically conductive material-lined quartz cylindrical ring and adapted to operate as a piezoelectric sensor. And furthermore, the gyroscope may further comprise a pair of electrodes lining an inner radial surface of the quartz cylindrical ring at radial sections common with the pair of electrodes arranged outside the electrically conductive material-lined quartz cylindrical ring and adapted to operate as a piezoelectric sensor, wherein activation between the two pairs of electrodes is time-multiplexed to alternate between electrostatic actuation and piezoelectric sensing operational modes.

Optionally, the electrically conductive material may be an annular liner continuously lining an outer radial surface of the quartz cylindrical ring, and the pair of electrodes lines an inner radial surface of the quartz cylindrical ring. Furthermore, the pair of electrodes may be adapted to be time-multiplexed to alternate between piezoelectric actuation and piezoelectric sensing operating modes. The gyroscope may further comprise at least one additional pair of electrodes lining the inner radial surface of the quartz cylindrical ring. Morevoer, said pairs of electrodes are each adapted to operate as a piezoelectric actuator or as a piezoelectric sensor.

Optionally, the electrically conductive material may an annular liner continuously lining an inner radial surface of the quartz cylindrical ring, and the pair of electrodes lines an outer radial surface of the quartz cylindrical ring. Furthermore, the pair of electrodes may be adapted to be time-multiplexed to alternate between piezoelectric actuation and piezoelectric sensing operating modes. And the gyroscope may further comprise at least one additional pair of electrodes lining the outer radial surface of the quartz cylindrical ring. And said pairs of electrodes may each adapted to operate as a piezoelectric actuator or as a piezoelectric sensor.

Optionally, the pair of electrodes lines an outer radial surface of the quartz cylindrical ring and the electrically conductive material may be divided into a pair of electrically conductive sections lining an inner radial surface of the quartz cylindrical ring opposite the electrodes. Furthermore, each electrode and opposing electrically conductive section pair may be adapted to be time-multiplexed to alternate between piezoelectric actuation and piezoelectric sensing operating modes. The gyroscope may further comprise at least one additional pair of electrodes lining the outer radial surface of the quartz cylindrical ring. Furthermore, each electrode and opposing electrically conductive section pair may be adapted to be time-multiplexed to alternate between piezoelectric actuation and piezoelectric sensing operating modes. And furthermore, in the piezoelectric sensing operating mode of an electrode and opposing electrically conductive section pair, the electrode and the electrically conductive section may be adapted to be switched between ground and piezoelectric sensor output.

These and other implementations and various features and operations are described in greater detail in the drawings, the description and the claims.

### BRIEF DESCRIPTION OF THE DRAWINGS

The accompanying drawings, which are incorporated into and forma a part of the disclosure, are as follows:

FIG. 1 is a top view of a first example embodiment of the cylindrical resonator gyroscope of the present invention having four electrostatic actuators/capacitive sensors.

FIG. 2 is a cross-sectional view taken along line A-A of FIG. 1.

FIG. 3 is a top view of a second example embodiment of the cylindrical resonator gyroscope of the present invention having eight electrostatic actuators/capacitive sensors.

FIG. 4 is a top view of a third example embodiment of the cylindrical resonator gyroscope of the present invention having a pair of electrostatic actuators and a pair of piezoelectric sensors.

FIG. 5 is a cross-sectional view taken along radial section B-B of FIG. 4.

FIG. 6 is a top view of a fourth example embodiment of the cylindrical resonator gyroscope of the present invention having four electrostatic actuators and four piezoelectric sensors.

FIG. 7 is a cross-sectional view taken along line C-C of FIG. 6.

FIG. 8 is a top view of a fifth example embodiment of the cylindrical resonator gyroscope of the present invention, having four quadrants arranged for piezloelectric actuation and sensing.

FIG. 9 is a cross-sectional view taken along line D-D of FIG. 8.

FIG. 10 is a cross-sectional view taken along line E-E of FIG. 8.

FIG. 11 is a top view of a sixth example embodiment of the cylindrical resonator gyroscope of the present invention, having four quadrants arranged for piezloelectric actuation and sensing, with a grounded metal liner along an inner surface of the resonating cylinder.

FIG. 12 is a top view of a seventh example embodiment of the cylindrical resonator gyroscope of the present invention, having four quadrants arranged for piezloelectric actuation and sensing, with a grounded metal liner along an outer surface of the resonating cylinder.

### DETAILED DESCRIPTION

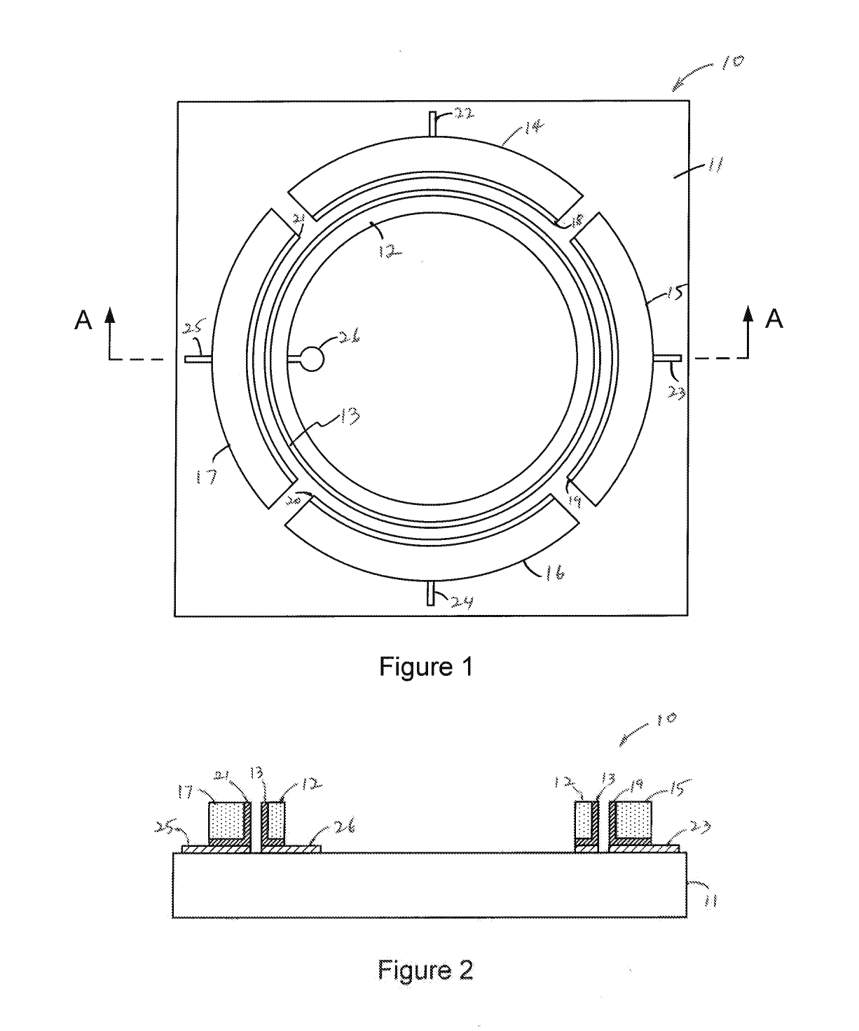

Turning now to the drawings, FIG. 1 shows a top view of a first example embodiment of the cylindrical resonator gyroscope of the present invention, generally indicated at reference character 10, and FIG. 2 shows a cross-sectional view taken along line A-A of FIG. 1. In particular, the gyroscope 10 is shown having a quartz cylinder 12 with one end connected to the substrate and an opposite open end. The quartz cylinder has an electrically conductive material liner 13 on a radially outer surface of the cylinder (though in other embodiments it may line a radially inner surface). The liner 13 is grounded, such as by launching pad 26 which may be used to route out to a contact pad either by wire bonds or metal vias through the substrate.

Four stationary structures 14-17 are also shown formed on the substrate 11, with electrodes 18-21 lining the radially inner surfaces of the structures 14-17, respectively. While four electrodes are shown, it is appreciated that a single pair of electrodes may be provided at a minimum which are arranged adjacent opposite sections of the electrically conductive material liner 13 to electrically induce resonance at the open end of the quartz cylindrical ring 12. In particular, the electrodes are arranged outside the cylindrical ring. It is appreciated that the structures 14-17 may be formed from the same quartz layer used to form the cylinder ring 12. And traces/leads 22-25 are provided which may be routed to die contact pads (not shown) for connecting respective electrodes 18-21 with control electronics (not shown) which power the electrodes for electrostatic actuation (e.g. independent of other electrodes). It is appreciated that actuation is preferably performed in pairs, such that electrodes 18 and 20 are activated together, and electrodes 19 and 21 are also activated together. FIG. 2 shows how the electrodes (e.g. 19), the metal liner 13, and the traces (23, 25) are used to connect (e.g. thermal compression bond) to the substrate.

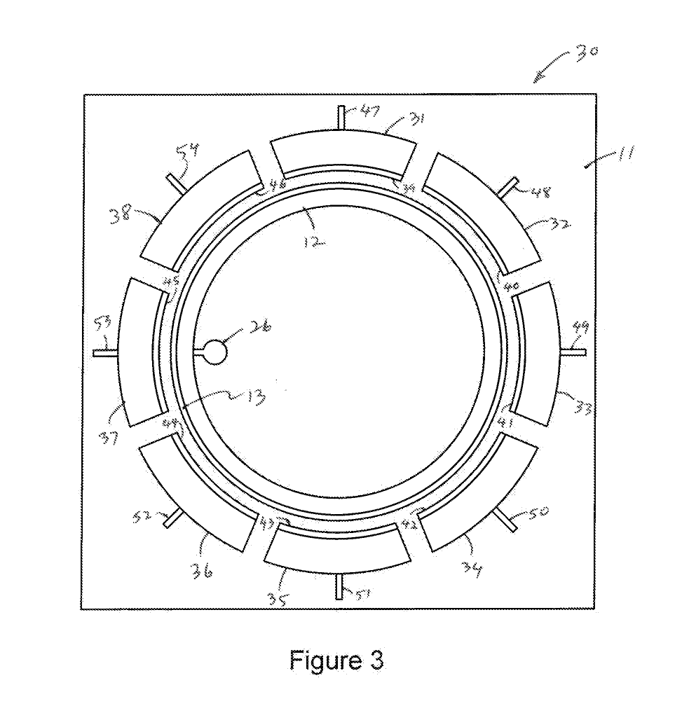

FIG. 3 is a top view of a second example embodiment of the cylindrical resonator gyroscope 30 of the present invention having eight electrostatic actuators/capacitive sensors. In particular, eight stationary structures 31-38 are provided having metal electrodes 39-46, respectively along a radially inner surface, and facing electrically conductive liner 13 of the quartz cylindrical ring. Further each of the electrodes 39-46 are connected by traces/leads 47-54, respectively, for connecting to control electronics (not shown) for electrostatically actuating independent of each other. As previously discussed, activation/actuation is preferably performed on opposite pairs (e.g. electrodes 39 and 43).

It is appreciated that the embodiments in FIGS. 1-3 show arrangements for electrostatic actuation and capacitive sensing. This may be accomplished by using the same electrodes for both operations by time multiplexing. In the alternative, electrostatic actuation and capacitive sensing operation may be performed in these arrangements by functionally separating electrodes, i.e. some electrodes for electrostatic actuation, some for capacitive sensing.

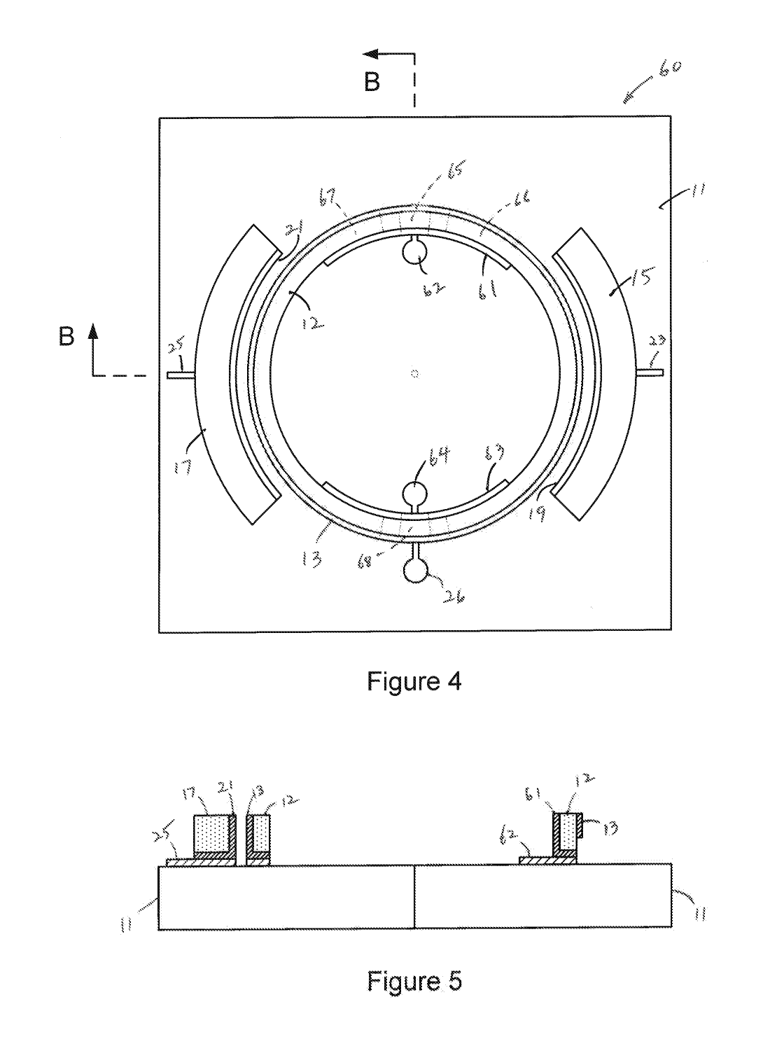

FIG. 4 is a top view of a third example embodiment of the cylindrical resonator gyroscope, 60 of the present invention having a pair of electrostatic actuators and a pair of piezoelectric sensors for actuating and sensing rotational vibration of quartz cylinder 12 with metal liner 13 on a radially outer surface. The metal liner 13 is connected to trace 26 which is connected ground. FIG. 5 is a cross-sectional view taken along radial section B-B of FIG. 4. In particular, stationary structures 15 and 17 having electrodes 19 and 21, respectively, connected to traces/leads 23 and 25, respectively, similar to FIG. 1. However, sensing is performed in this embodiment by piezoelectric effect using electrodes 61 and 63 formed on a radially inner surface of the quart cylinder. The electrodes 61, 63 are connected by traces/leads 62, 64, respectively, to control electronics (not shown). Furthermore, as shown in FIGS. 4 and 5, the electrodes 61 and 63 are not electrically connected from the metal liner 13 by breaks (shown as broken lines) which form a pad 65 below the cylindrical ring 12 electrically connected to the electrode 61, and pads 66 and 67 electrically connected to the metal liner 13 and lead 26.

It is appreciated that the embodiments in FIGS. 4 and 5 show an arrangement which may be used for electrostatic actuation and piezoelectric sensing (i.e. by the piezoelectric effect), or piezoelectric actuation and capacitive sensing. For electrostatic actuation and piezoelectric sensing, this may be accomplished by functionally separating electrodes: some electrodes for electrostatic actuation, some for piezoelectric sensing. For piezoelectric actuation and capacitive sensing, this may be accomplished by functionally separated electrodes: some electrodes for piezoelectic actuation, some for capacitive sensing.

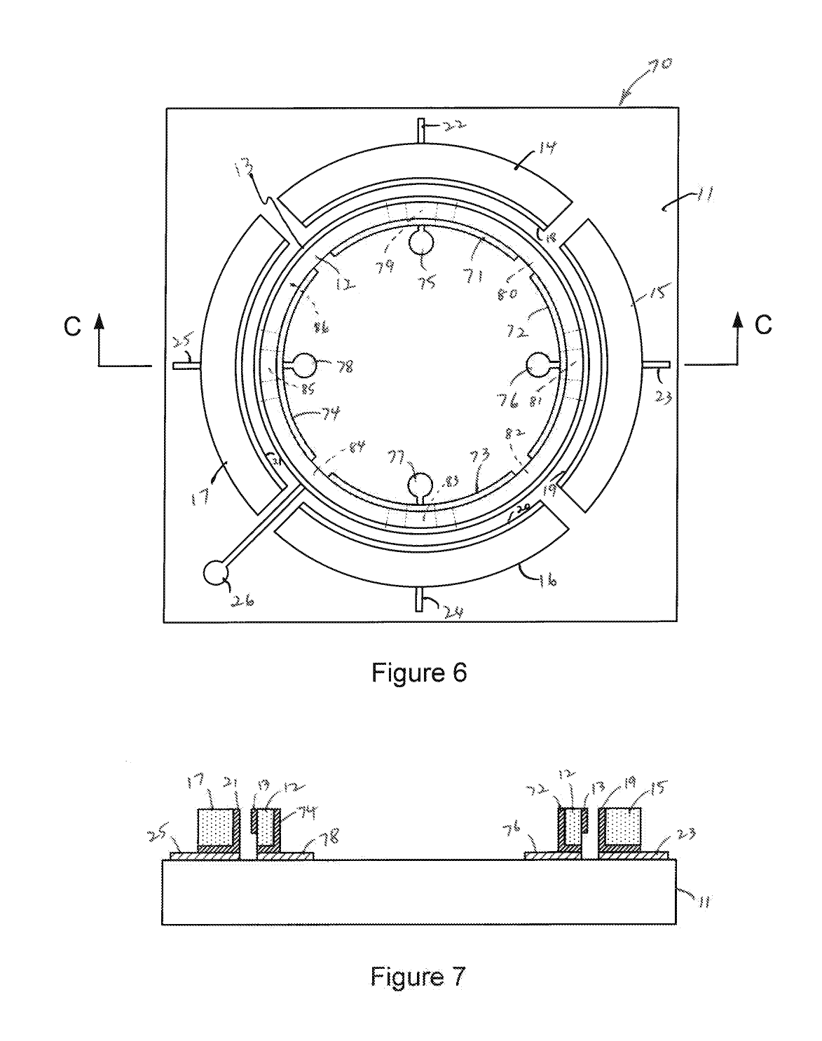

FIG. 6 is a top view of a fourth example embodiment of the cylindrical resonator gyroscope 70 of the present invention having four electrostatic actuators and four piezoelectric sensors. And FIG. 7 is a cross-sectional view taken along line C-C of FIG. 6. In this embodiment, four stationary structure 14-17 are provided similar to FIG. 1, having electrodes 18-21, respectively, and traces/leads 22-25, respectively. The cylindrical ring 12 also has a radially outer metal liner 13 also similar to FIG. 1. However, piezoelectric sensing is performed by electrodes 71-74 formed on the inner surface of the cylindrical ring 12, which are connected to traces leads 75-78, respectively. Similar to the arrangement of FIG. 4, the electrodes 71-74 are not electrically connected from the metal liner 13 by breaks (shown as broken lines) which form pad 79 below the cylindrical ring 12 electrically connected to the electrode 71, pad 81 below the cylindrical ring 12 electrically connected to the electrode 72, pad 83 below the cylindrical ring 12 electrically connected to the electrode 73, and pad 85 below the cylindrical ring 12 electrically connected to the electrode 74. Furthermore, pads 80, 82, 84, and 86 are electrically connected to the metal liner 13.

It is appreciated that the embodiments in FIGS. 6 and 7 show an arrangement which may be used for electrostatic actuation and piezoelectric sensing (i.e. by the piezoelectric effect), or piezoelectric actuation and capacitive sensing. In the case for either electrostatic actuation and piezoelectric sensing, or piezoelectric actuation and capacitive sensing, this may be accomplished by using a common ground, but different electrodes.

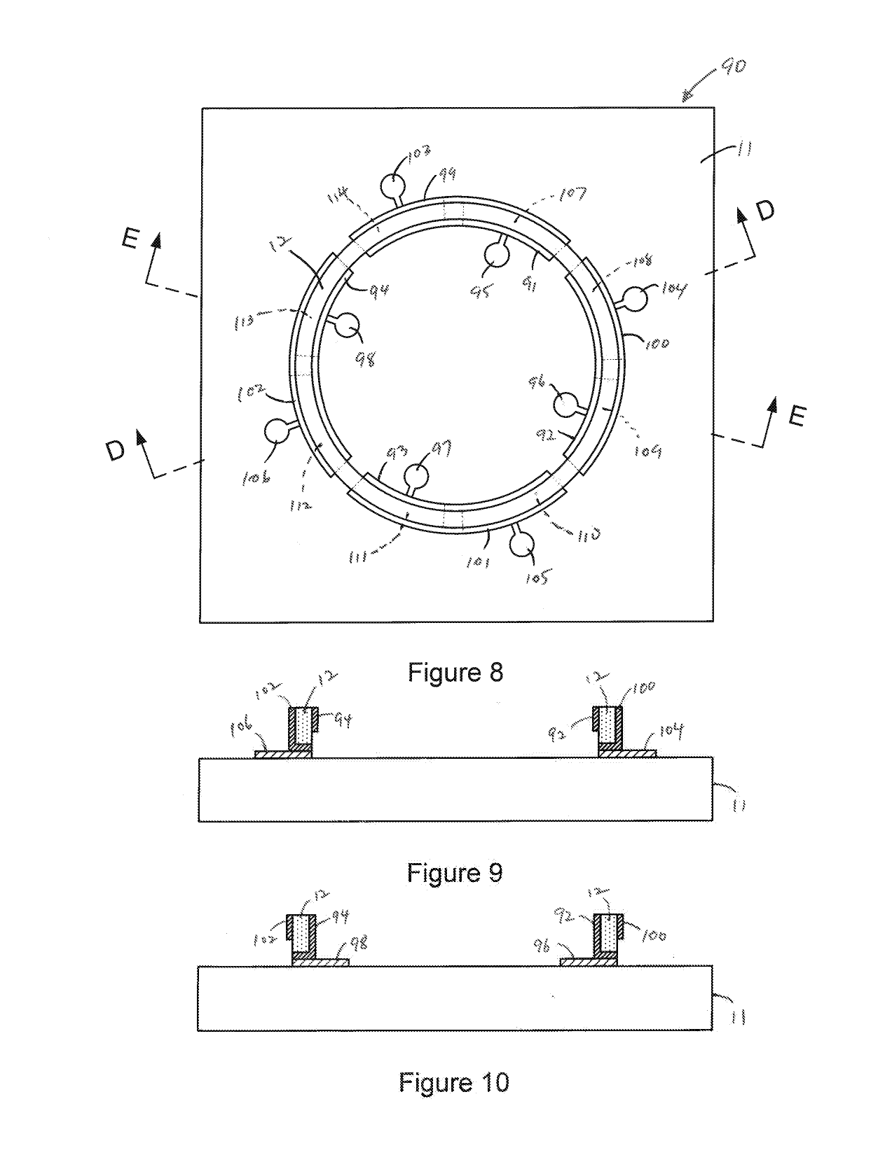

FIG. 8 is a top view of a fifth example embodiment of the cylindrical resonator gyroscope 90 of the present invention, having four quadrants arranged for piezloelectric actuation and piezoelectric sensing. In particular, cylindrical ring 12 has four electrodes 91-94 formed along a radially inner surface and connected to traces/leads 95-98, respectively, and four electrodes 99-102 formed along a radially outer surface and connected to traces/leads 103-106, respectively. FIGS. 9 and 10 show cross-sectional views taken along line D-D and line E-E, respectively, of FIG. 8, illustrating how the inner and outer electrodes are electrically separated below the cylindrical ring. It is appreciated that in this configuration, piezoelectric sensing may be performed by a radially inner electrode (e.g. 94) and an opposing radially outer electrode (e.g. 100) during a sensing phase, so that a differential signal may be electrically processed to cancel out noise.

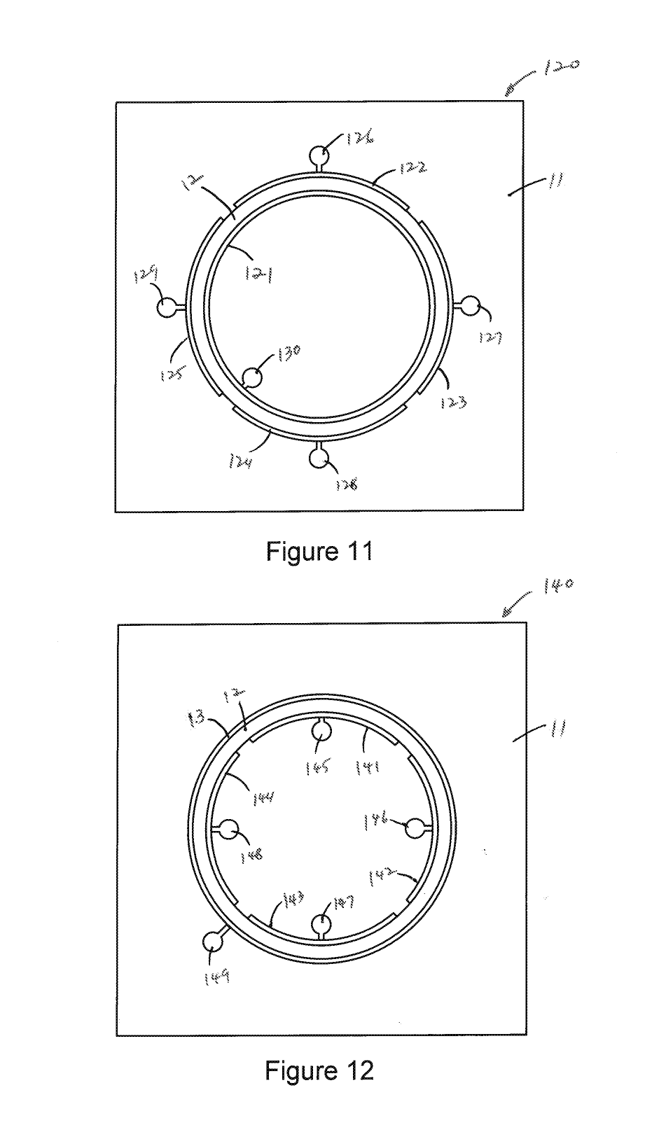

FIG. 11 is a top view of a sixth example embodiment of the cylindrical resonator gyroscope 120 of the present invention, having four quadrants arranged for piezloelectric actuation and piezoelectric sensing, with a grounded metal liner along an inner surface of the resonating cylinder. The cylindrical ring 12 is shown having a continuous annular metal liner 121 along a radially inner surface and connected to trace/lead 130. Additionally, the cylindrical ring 12 also has four electrodes 122-125 formed along a radially outer surface thereof with traces/leads 126-129, respectively.

And FIG. 12 is a top view of a seventh example embodiment of the cylindrical resonator gyroscope 140 of the present invention, having four quadrants arranged for piezoelectric actuation and piezoelectric sensing, with a grounded metal liner along an outer surface of the resonating cylinder. In this configuration, the cylindrical ring 12 has a grounded metal liner 13 along a radially outer surface thereof, and four electrodes 141-144 along a radially inner surface of the cylindrical ring 12.

Although the description above contains many details and specifics, these should not be construed as limiting the scope of the invention but as merely providing illustrations of some of the presently preferred embodiments of this invention. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present invention fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present invention, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

We claim:

1. A quartz vibratory gyroscope comprising:
a substrate;
a quartz cylindrical ring having one end connected to the substrate and an opposite open end, and a radial surface lined with an electrically conductive material; and
a pair of electrodes arranged adjacent opposite sections of the electrically conductive material to electrically induce resonance at the open end of the quartz cylindrical ring.

2. The quartz vibratory gyroscope of claim 1,
wherein the electrically conductive materials lines an outer radial surface of the quartz cylindrical ring, and the pair of electrodes is arranged outside the electrically conductive material-lined quartz cylindrical ring.

3. The quartz vibratory gyroscope of claim 2,
wherein the pair of electrodes is adapted to be time-multiplexed to alternate between electrostatic actuation and capacitive sensing operational modes.

4. The quartz vibratory gyroscope of claim 2,
further comprising at least one additional pair of electrodes arranged adjacent opposite sections of the electrically conductive material.

5. The quartz vibratory gyroscope of claim 4,
wherein said pairs of electrodes are each adapted to operate as an electrostatic actuator or as a capacitive sensor.

6. The quartz vibratory gyroscope of claim 2,
further comprising a pair of electrodes lining an inner radial surface of the quartz cylindrical ring at different radial sections from the pair of electrodes arranged outside the electrically conductive material-lined quartz cylindrical ring and adapted to operate as a piezoelectric sensor.

7. The quartz vibratory gyroscope of claim 2,
further comprising a pair of electrodes lining an inner radial surface of the quartz cylindrical ring at radial sections common with the pair of electrodes arranged outside the electrically conductive material-lined quartz cylindrical ring and adapted to operate as a piezoelectric sensor, wherein activation between the two pairs of electrodes is time-multiplexed to alternate between electrostatic actuation and piezoelectric sensing operational modes.

8. The quartz vibratory gyroscope of claim 1,
wherein the electrically conductive material is an annular liner continuously lining an outer radial surface of the quartz cylindrical ring, and the pair of electrodes lines an inner radial surface of the quartz cylindrical ring.

9. The quartz vibratory gyroscope of claim 8,
wherein the pair of electrodes is adapted to be time-multiplexed to alternate between piezoelectric actuation and piezoelectric sensing operating modes.

10. The quartz vibratory gyroscope of claim 8,
further comprising at least one additional pair of electrodes lining the inner radial surface of the quartz cylindrical ring.

11. The quartz vibratory gyroscope of claim 10,
wherein said pairs of electrodes are each adapted to operate as a piezoelectric actuator or as a piezoelectric sensor.

12. The quartz vibratory gyroscope of claim 1,
wherein the electrically conductive material is an annular liner continuously lining an inner radial surface of the quartz cylindrical ring, and the pair of electrodes lines an outer radial surface of the quartz cylindrical ring.

13. The quartz vibratory gyroscope of claim 12,
wherein the pair of electrodes is adapted to be time-multiplexed to alternate between piezoelectric actuation and piezoelectric sensing operating modes.

14. The quartz vibratory gyroscope of claim 12,
further comprising at least one additional pair of electrodes lining the outer radial surface of the quartz cylindrical ring.

15. The quartz vibratory gyroscope of claim 14,
wherein said pairs of electrodes are each adapted to operate as a piezoelectric actuator or as a piezoelectric sensor.

16. The quartz vibratory gyroscope of claim 1,
wherein the pair of electrodes lines an outer radial surface of the quartz cylindrical ring and the electrically conductive material is divided into a pair of electrically conductive sections lining an inner radial surface of the quartz cylindrical ring opposite the electrodes.

17. The quartz vibratory gyroscope of claim 16,
wherein each electrode and opposing electrically conductive section pair is adapted to be time-multiplexed to alternate between piezoelectric actuation and piezoelectric sensing operating modes.

18. The quartz vibratory gyroscope of claim 16,
further comprising at least one additional pair of electrodes lining the outer radial surface of the quartz cylindrical ring.

19. The quartz vibratory gyroscope of claim 18,
wherein each electrode and opposing electrically conductive section pair is adapted to be time-multiplexed to alternate between piezoelectric actuation and piezoelectric sensing operating modes.

20. The quartz vibratory gyroscope of claim 19,
wherein in the piezoelectric sensing operating mode of an electrode and opposing electrically conductive section pair, the electrode and the electrically conductive section are adapted to be switched between ground and piezoelectric sensor output.
